(19) United States
(12) Patent Application Publication
(10) Pub. No.: US 2023/0071037 A1
(43) Pub. Date: Mar. 9, 2023

(54) APPARATUS FOR RECOGNIZING USER COMMAND USING NON-CONTACT GAZE-BASED HEAD MOTION INFORMATION AND METHOD USING THE SAME

(71) Applicant: ELECTRONICS AND TELECOMMUNICATIONS RESEARCH INSTITUTE, Daejeon (KR)

(72) Inventors: Ho-Won KIM, Daejeon (KR); Cheol-Hwan YOO, Daejeon (KR); Jang-Hee YOO, Daejeon (KR); Jae-Yoon JANG, Daejeon (KR)

(21) Appl. No.: 17/558,104

(22) Filed: Dec. 21, 2021

(30) Foreign Application Priority Data
Sep. 9, 2021 (KR) 10-2021-0120094

(51) Int. Cl. G06F 3/01; G06F 3/0482

(52) U.S. Cl. CPC G06F 3/013; G06F 3/012; G06F 3/0482

(57) ABSTRACT

Disclosed herein are an apparatus for recognizing a user command using non-contact gaze-based head motion information and a method using the same. The method includes monitoring the gaze and the head motion of a user based on a sensor, displaying a user interface at a location corresponding to the gaze based on gaze-based head motion information acquired by combining the gaze and the head motion, and recognizing a user command selected from the user interface.

### CROSS REFERENCE TO RELATED APPLICATION

This application claims the benefit of Korean Patent Application No. 10-2021-0120094, filed Sep. 9, 2021, which is hereby incorporated by reference in its entirety into this application.

### BACKGROUND OF THE INVENTION

### 1. Technical Field

The present invention relates generally to technology for recognizing a user command using non-contact gaze-based head motion information, and more particularly to technology capable of issuing a user command to a system by outputting a user interface at a desired location using only the gaze and the head motion of a user, without contact.

### 2. Description of the Related Art

Methods by which a system including the capability to perform certain functions recognizes a user command include a contact-based method using a keyboard, a mouse, a button, a touch, or the like, and a non-contact-based method using eye (gaze) tracking based on analysis of a user image captured by a camera, recognition of hand and body gestures, voice recognition, or the like.

The method using a gesture requires space for recognizing the gesture, and has a disadvantage in that it is difficult to use the method when a user is not able to use his/her hands or body due to other things the user intends to do, for example, when the user is doing whole-body exercise, such as yoga, or is holding a tool or working at a jobsite.

Also, the method using a gesture has an issue from the aspect of User Experience (UX) in that a gesture command requires intentional effort on the part of a user, an issue of a low recognition rate arising from the complexity of a command motion, an issue in which it is difficult for a system to distinguish a motion for starting a user command from a motion irrelevant to a command, among general user motions, and the like.

The method using eye tracking is mainly used for the purpose of receiving a user command, instead of moving a mouse cursor. For example, a system recognizes the gaze direction of a user located in front of a screen using a camera and recognizes the location on the screen at which the user is looking, thereby recognizing a user command. In this case, calibration based on the characteristics of the eyeballs of the user is required for precise eye tracking. Further, in order to use the result of precise eye tracking, the user must constrain movement to the space within which calibration is performed.

Also, because the method using eye tracking uses a gaze direction as the means for inputting a command, when a user who is driving a vehicle gives a command using a large Head-Up Display (HUD) located in front thereof, it is likely to distract the user from keeping his/her eyes on the road. Similarly, when using a Head-Mounted Display (HMD) or Augmented-Reality (AR) glasses, a user has to move a gaze direction to the location of a specific button on the screen displayed to the user in order to push the button, which causes a UX issue in which the user command input method impedes a desired activity, such as viewing content, or the like.

For example, when it is necessary to immediately stop the operation of a machine using an emergency stop button at an industrial site, the conventional physical button has limitations in use if a user is located distant from the button or the user has to move around a large working area. Also, while at work, it is difficult to give a command using the conventional gesture-based method or the conventional eye-tracking-based method.

### DOCUMENTS OF RELATED ART

(Patent Document 1) U.S. Application Publication No. 10-2020-0285379, published on Sep. 10, 2020 and titled “System for gaze interaction”.

### SUMMARY OF THE INVENTION

An object of the present invention is to display an interface for inputting a user command at the location at which the gaze of a user remains, without disturbing the situation in which the user uses his/her body for a desired activity or in which the user is required to keep looking forwards, thereby enabling the user command to be given to a system.

Another object of the present invention is to give a user command to a system in real time in an interactive manner using the minimum possible amount of movement.

A further object of the present invention is to provide technology capable of being used in various fields in which a user needs to give a command to a system in real time through AI based on analysis of an image of the face of a user by replacing, supplementing, or assisting the conventional user command transfer system.

Yet another object of the present invention is to give various user commands recognized through natural user experience (UX) to a system in an interactive manner in various environments in which contact-based input or non-contact-based input is used.

Still another object of the present invention is to overcome the limitation of a large display, such as a media wall or the like, in which it is difficult to receive a user command merely by disposing a conventional GUI for receiving the user command, and to enable an individual user to transfer a desired command at a location at which the user can comfortably gaze by providing a preset GUI command set at the location on the large display at which the gaze of the user remains.

In order to accomplish the above objects, a method for recognizing a user command according to the present invention includes monitoring the gaze and the head motion of a user based on a sensor; displaying a user interface at the location corresponding to the gaze based on gaze-based head motion information acquired by combining the gaze and the head motion; and recognizing a user command selected from the user interface.

Here, the location at which the user interface is displayed may change so as to match a location on which the gaze is fixed in a display area, and the display area may be a large display wider than the field of view of the user.

Here, the user interface may provide a unique command set corresponding to the user.

Here, the gaze-based head motion information may correspond to direction information input by the head motion in the state in which the gaze is fixed.

Here, monitoring the gaze and the head motion may comprise detecting the gaze-based head motion information in consideration of head motion characteristics of the user.

Here, the head motion characteristics may include at least one of a head turn angle, a head turn speed, a time during which a head is kept turned, a time taken to turn back the head, and positions of eyes and extents of opening of eyelids according to the turn of the head.

Here, the method may further include acquiring multiple gaze-based head motions of the user and matching the head motion characteristics extracted based on the multiple gaze-based head motions with user identification information, thereby registering the user.

Here, registering the user may include outputting a motion-inducing message for prompting to perform the multiple gaze-based head motions; and calibrating the head motion characteristics in consideration of a difference between a first motion prompted by the motion-inducing message and a second motion corresponding to the multiple gaze-based head motions.

Here, calibrating the head motion characteristics may comprise calibrating the head motion characteristics while moving the location of a gaze point for prompting to perform the multiple gaze-based head motions.

Here, the unique command set may be set so as to correspond to a command list and a layout in which area characteristics of the location on which the gaze is fixed in a display area are taken into consideration.

Also, an apparatus for recognizing a user command according to an embodiment of the present invention includes a processor for monitoring the gaze and the head motion of a user based on a sensor, displaying a user interface at the location corresponding to the gaze based on gaze-based head motion information acquired by combining the gaze and the head motion, and recognizing a user command selected from the user interface; and memory for storing the user interface.

Here, the location at which the user interface is displayed may change so as to match a location on which the gaze is fixed in a display area, and the display area may be a large display wider than the field of view of the user.

Here, the user interface may provide a unique command set corresponding to the user.

Here, the gaze-based head motion information may correspond to direction information input by the head motion in the state in which the gaze is fixed.

Here, the processor may detect the gaze-based head motion information in consideration of head motion characteristics of the user.

Here, the head motion characteristics may include at least one of a head turn angle, a head turn speed, a time during which a head is kept turned, a time taken to turn back the head, and positions of eyes and extents of opening of eyelids according to the turn of the head.

Here, the processor may acquire multiple gaze-based head motions of the user and match the head motion characteristics extracted based on the multiple gaze-based head motions with user identification information, thereby registering the user.

Here, the processor may output a motion-inducing message for prompting to perform the multiple gaze-based head motions, and may calibrate the head motion characteristics in consideration of a difference between a first motion prompted by the motion-inducing message and a second motion corresponding to the multiple gaze-based head motions.

Here, the processor may calibrate the head motion characteristics while moving the location of a gaze point for prompting to perform the multiple gaze-based head motions.

Here, the unique command set may be set so as to correspond to a command list and a layout in which area characteristics of the location on which the gaze is fixed in a display area are taken into consideration.

### BRIEF DESCRIPTION OF THE DRAWINGS

The above and other objects, features, and advantages of the present invention will be more clearly understood from the following detailed description taken in conjunction with the accompanying drawings, in which:

FIGS. 1 to 2 are views illustrating a system for recognizing a user command using non-contact gaze-based head motion information according to an embodiment of the present invention;

FIG. 3 is a flowchart illustrating a method for recognizing a user command using non-contact gaze-based head motion information according to an embodiment of the present invention;

FIGS. 4 to 7 are views illustrating an example of output of a user interface according to the present invention;

FIGS. 8 to 9 are views illustrating an example of a user registration process according to the present invention;

FIG. 10 is a flowchart illustrating in detail the procedure of processing a gaze-based head motion command in a user command recognition process according to an embodiment of the present invention;

FIGS. 11 to 15 are views illustrating an example of a unique command set according to the present invention;

FIG. 16 is a view illustrating an example of a unique command set, the command list of which is set differently depending on display area characteristics according to the present invention;

FIG. 17 is a view illustrating an example of a unique command set, the layout of which is set differently depending on display area characteristics according to the present invention;

FIG. 18 is a view illustrating an embodiment of the structure of a system for recognizing a user command using non-contact gaze-based head motion information according to the present invention; and

FIG. 19 is a view illustrating an apparatus for recognizing a user command using non-contact gaze-based head motion information according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

The present invention relates to user command recognition technology through which a system is able to recognize a non-contact-based user command in real time in an interactive manner by capturing images of the face and the head of a user using a camera, an image sensor, or the like installed in a computer, a tablet PC, a cell phone, a robot, a vehicle, or an elevator, or at an industrial site or a hospital, and by identifying the identity, the eye gaze direction, the head pose, and the like of the user in real time based on the captured image in an environment in which free movement of the user is required, in which the user has to maintain the gaze direction for his/her work, in which it is difficult to give a command to a system using hands (e.g., using a keyboard, a mouse, a touch, button input, a hand gesture, or the like), or in which it is difficult to give a command using voice (e.g., a noisy environment, an environment in which silence is required, an environment in which it is difficult to control noise, or the like).

In order to give a command to a system, the conventional non-contact-based user command transfer method requires a motion or a gaze direction that may not match the purpose of the current behavior of a user, but the present invention is different from the conventional method in that a user command may be issued to a system based on natural user experience (UX) while a user is conducting a desired activity.

The present invention intends to propose technology capable of being used in 1) various industrial fields and life fields in which a system receives a user command through a keyboard, a mouse, a touch, button input, a body gesture, or the like, 2) the case in which the conventional user command transfer system is replaced, supplemented, or assisted without affecting the original purpose, such as keeping one's eyes forward while driving, and 3) various fields in which a user needs to give a command to a system in real time using AI based on face image analysis.

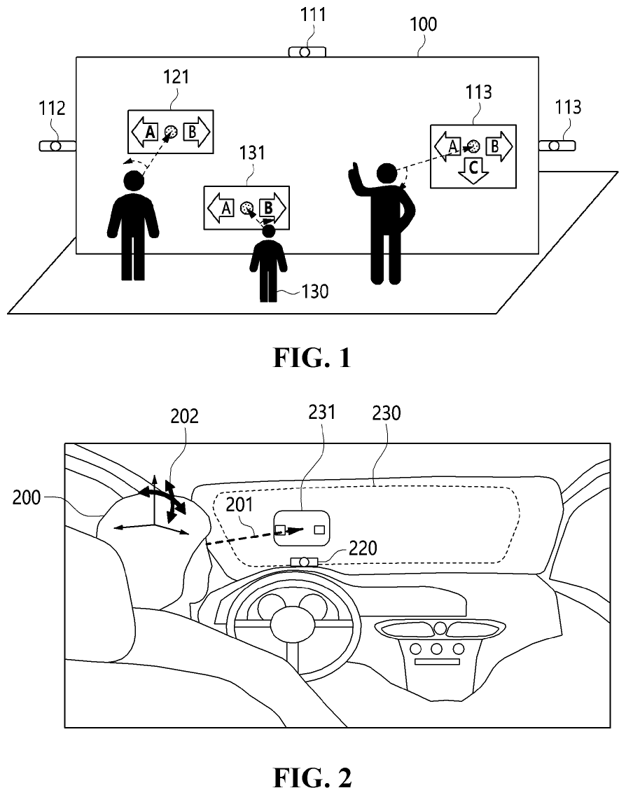

FIGS. 1 to 2 are views illustrating a system for recognizing a user command using non-contact gaze-based head motion information according to an embodiment of the present invention.

First, referring to FIG. 1, users 120, 130 and 140, who view exhibits in the form of user-customized content, or the like displayed on a media wall, are given as examples of users of a system for recognizing a user command using non-contact gaze-based head motion information.

Here, a module corresponding to a user command recognition apparatus is not separately illustrated in FIG. 1, but it may be assumed that a special user command recognition apparatus is provided so as to operate in conjunction with a display area 100 and multiple cameras 111 to 113 for monitoring the users 120, 130 and 140.

Here, a single camera or multiple cameras may be provided as the cameras 111 to 113 for monitoring the users 120, 130 and 140 located within the range of the display area 100 taking the form of a media wall. Accordingly, the gazes and the head motions of the users 120, 130 and 140 may be monitored using the cameras 111 to 113.

Here, the display area 100 may output user interfaces 121, 131 and 141 at the locations at which the gazes of the respective users 120, 130 and 140 are located.

For example, as illustrated in FIG. 1, when a user gives a non-contact gaze-based head motion command at the location at which the user is able to comfortably look, regardless of the height of the user or the distance between the user and the media wall, a command GUI may be displayed at the corresponding location, and the user command may be received and executed.

Also, referring to FIG. 2, a driver in a vehicle is given as an example of the user of the system for recognizing a user command using non-contact gaze-based head motion information.

Here, a module corresponding to a user command recognition apparatus is not separately illustrated in FIG. 2, but it may be assumed that a user command recognition apparatus is installed in the vehicle so as to operate in conjunction with a display area 230 and a camera 220 for monitoring a user 200.

The camera 220 is installed at a location from which the camera 220 is capable of capturing an image of the head and eyes of the user 200, thereby monitoring the gaze 201 and the head motion 202 of the user 200.

Here, a wearable device, such as AR glasses, may monitor the gaze using a camera installed therein, and may monitor a head motion using a separate motion sensor or the like.

In the present invention, a user command may be received by combining the gaze 201 and the head motion 202 detected through real-time monitoring.

For example, a user command may be recognized based on the head motion 202 sensed in the state in which the gaze 201 is fixed on one place.

Comparing this method with the conventional method, a user is able to give a user command in the state in which the user looks at what the user intends to do, rather than being required to look at a preset location.

That is, because the conventional eye-tracking-based user command recognition method is configured such that a user command is transferred only when a user looks at a specific location on a display, it is difficult for the user to keep looking forwards while driving, as illustrated in FIG. 2, which may increase the risk of an accident.

However, according to the present invention, the user 200 may give a desired command to a system by performing a simple head motion 202 while keeping his/her eyes 201 forwards for safe driving.

The display area 230 may output a user interface 231 at the location at which the gaze 201 of the user is located according to the demand of the user 200 so as to receive the user command in an interactive manner.

For example, the user interface 231 for a user command may be displayed at a location at which the user 200 places his/her gaze 201 while driving using a Head-Up Display (HUD) provided on the windshield of the vehicle, as shown in FIG. 2.

Here, a unique command set preset by the user 200 may be provided through the user interface 231. For example, the unique command set may be displayed so as to match the form set by the user or the order or scenario defined by the user.

When the unique command set for the user 200 is displayed, a user command may be transferred to a system by turning the head to the left or right or lifting or lowering the head while maintaining the gaze 201, which is fixed when the user interface 231 is called.

Here, a subcommand set of the recognized user command may be displayed, or the recognized user command may be executed.

As illustrated in FIG. 1 and FIG. 2, the system for recognizing a user command using non-contact gaze-based head motion information according to the present invention is applied to a media wall exhibition or a vehicle, whereby the convenience of individual users may be improved or the risk of vehicle accidents may be reduced.

For example, each user who views an exhibit in an exhibition in which content is provided through a large screen may float a desired command GUI at a location at which the user is able to comfortably look, and may give a command to a system.

In another example, when a driver looks at the left or right sideview mirror of a vehicle or manipulates a dashboard control in the vehicle while driving, there is the possibility of an accident occurs due to failure to keep looking forwards. However, the application of the configuration of the present invention enables a driver to display an image captured by a camera installed in the sideview mirror of a vehicle in a front display or to manipulate a button on a dashboard merely by performing a predefined head motion, such as lifting and then lowering the head, while continuing to look forwards. Alternatively, when a system for a voice command is installed in a vehicle, the voice command may be executed after muting audio using a simple head motion by applying the configuration of the present invention.

In this case, a driver is able to keep looking forwards and hold a steering wheel while issuing a user command, and at the same time, the driver may change lanes by checking an image of a rear area in a desired direction through a Head-Up Display (HUD). In this example, a GUI through the HUD is not essential, and fast transfer of a user command may be realized by setting, in advance, a command set for a user, without a GUI display on the HUD.

In another example, it may be assumed that a user is doing an at-home workout, e.g., squats, yoga, or the like, while viewing content displayed on a TV. In this case, input of a user command may be required in order to adjust the playback speed of the content, to switch the scene for the next exercise, to set an option, or the like during exercise. Here, when the configuration of the present invention is applied, the user performs a gaze-based head motion (a combination of a gaze direction and a head motion) according to a GUI command set that is displayed by being superimposed on the TV through a camera installed in the TV or installed in front of the user, thereby transferring a user command to the content without disturbing the flow of exercise.

In another example, even when a button having a function of immediately stopping operation of a device or a system in the event of an emergency is present at an industrial site, a user may not be able to push the button, or may be located distant therefrom, in the event of an emergency. Here, when the configuration of the present invention is applied, the device or the system may be controlled from a long distance away. That is, in the event of an emergency, the user performs a gaze-based head motion for a camera installed at the site, thereby switching the system to a standby mode for recognizing a non-contact-based user command. When the system is switched to a standby mode, the user performs a predefined head motion while maintaining the gaze at the camera, thereby immediately stopping the system. Here, the system may operate after checking whether the user who issued the command via the camera is a user having authority to immediately stop the system. Also, the system may notify the user of recognition of the non-contact-based user command or the switch to the standby mode for recognition using a sound or illumination that is easily noticeable from a long distance (e.g., by changing the color of the illumination or by lighting illumination at a specific location), thereby providing feedback on the command reception state to the user.

In another example, in a medical field, a doctor may give a command to a system according to the situation in an interactive manner through a camera installed in a monitor or AR glasses, without being disturbed during an operation. Also, a patient who is not able to move may give a command for calling a nurse, making an emergency call, or the like to a system merely by performing a head motion while lying in bed.

In another example, when playing a musical instrument, such as a piano, with two hands, a user may turn the page of a score without using hands by performing a gaze-based head motion. Here, the user command based on the non-contact gaze and the head motion of the user may be recognized using a camera for monitoring the face of the performer by being installed near the score or using a camera installed in the tablet PC that outputs the score.

In another example, in the situation in which a virus can be spread by contact, pushing a button in an elevator may be performed in a contactless manner through a gaze-based head motion according to the present invention.

As described above, the present invention implements a command system differently from the conventional command system based on eye tracking, and may clearly identify a command motion performed by a user through a combination of a fixed gaze and a head motion.

Hereinafter, technology for recognizing a user command using non-contact gaze-based head motion information, through which a desired command is capable of being recognized in an interactive manner through the minimum possible amount of movement so as not to restrict the activity of a user when the user performs the activity while freely moving within the field of view of a camera, will be described in detail.

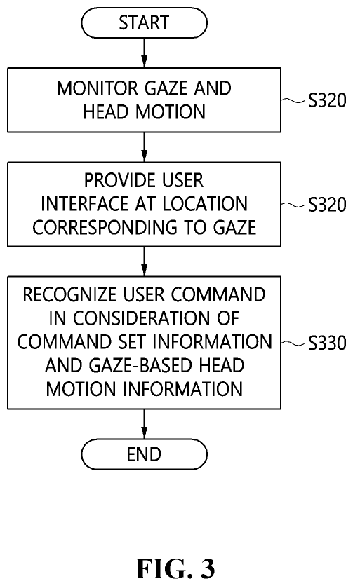

FIG. 3 is a flowchart illustrating a method for recognizing a user command using non-contact gaze-based head motion information according to an embodiment of the present invention.

Referring to FIG. 3, in the method for recognizing a user command using non-contact gaze-based head motion information according to an embodiment of the present invention, the gaze and the head motion of a user are monitored using a sensor at step S310.

For example, the gaze and the head motion of the user may be monitored using an image sensor, such as a camera, or a motion sensor capable of sensing motion.

Accordingly, the sensor may be installed at a location at which it is possible to monitor the gaze and the head motion of the user.

For example, when the configuration of the present invention is applied to vehicle driving, a camera may be provided at a location from which the camera is capable of capturing an image of the face of a driver sitting in a driver's seat.

In another example, when the configuration of the present invention is applied to playing of a musical instrument, a camera may be provided near a score such that the camera is capable of capturing an image of the face of a performer playing a musical instrument.

When a wearable device worn by a user, such as AR glasses, is used, the gaze of the user may be monitored using a camera that is capable of directly capturing an image of the eyes of the user by being installed in the device. Here, information about the head motion of the user may be received from a sensor, which is capable of receiving information about changes in the head pose of a user, such as a gyro sensor installed in the device, or may be received in the form of heading information of the device, which is acquired based on a SLAM method using a single camera or multiple cameras capable of viewing the outside by being installed in the device so as to face outward.

Also, in the method for recognizing a user command using non-contact gaze-based head motion information according to an embodiment of the present invention, a user interface is displayed at a location corresponding to the gaze based on gaze-based head motion information acquired by combining the gaze and the head motion at step S320.

Here, the location at which the user interface is displayed may change so as to match the location on which the gaze is fixed within a display area, and the display area may be a large display that is wider than the field of view of the user.

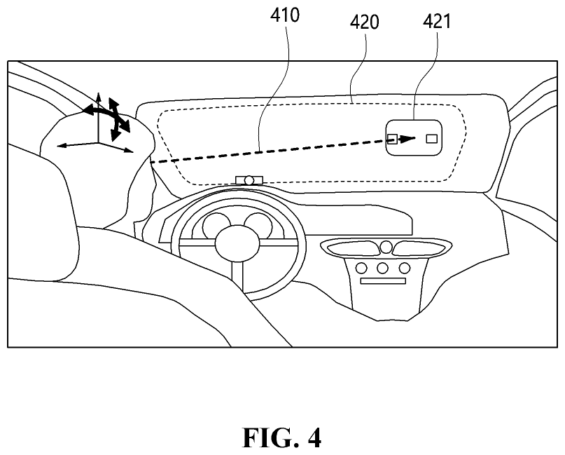

For example, FIG. 4 shows an example in which a driver calls a user interface while driving. Generally, a driver has to look ahead while driving, but the driver may look to the right, rather than ahead, when turning right or changing to the right lane, as illustrated in FIG. 4. In this case, the gaze 410 of the user is naturally located at the right side of a display area 420, and the user interface 421 provided based on gaze-based head motion information may be displayed to the right, rather than directly in front of the user.

Here, if the user interface 421 is displayed in front of the user, the user has to move the gaze and look straight ahead in order to check the user interface 421, because the display area 420 is wider than the field of view of the user. However, because the user is trying to turn right or to change to the right lane, the gaze direction for the behavior intended by the user conflicts with the gaze direction for checking the user interface 421.

However, according to the present invention, the user interface 421 is displayed at the location at which the user currently places his/her gaze 410, which may reduce inconvenience that is caused when the user has to move the gaze 410 in a manner conflicting with the current intended behavior.

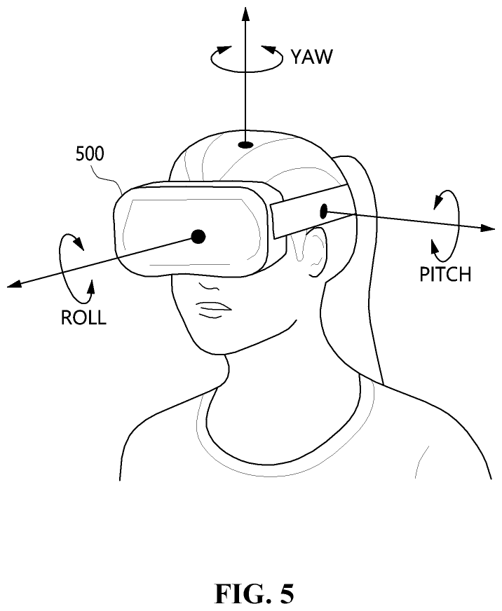

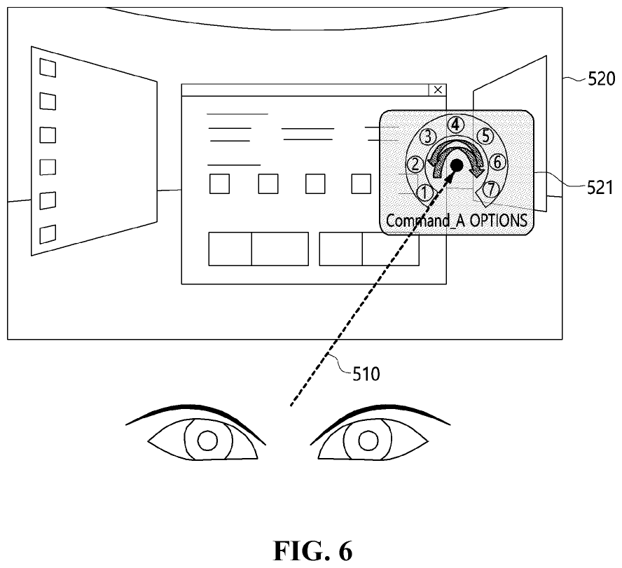

In another example, FIGS. 5 to 6 illustrate an example in which a user interface 521 is provided in a display area 520 viewed through an HMD 500.

Here, the HMD 500 may detect the head motion of a user using a motion sensor or gyro sensor capable of directly sensing the head pose of the user, as illustrated in FIG. 5. Also, the gaze 510 of the user is monitored using a camera capable of directly capturing an image of the eyes of the user by being installed in the HMD 500, whereby a user interface 521 for a user command may be displayed at the location at which the user places the gaze 510 in the display area 520 shown to the user.

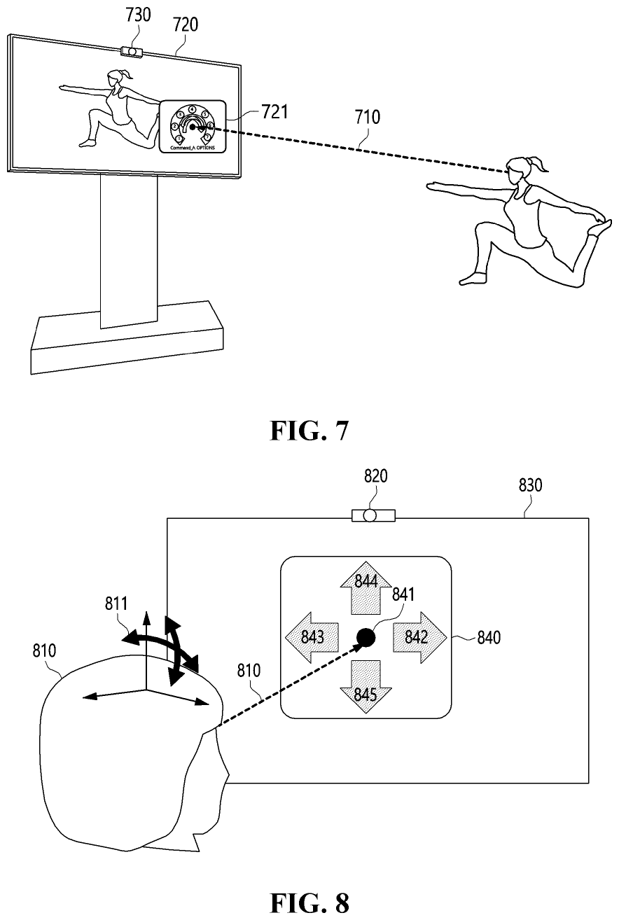

In another example, FIG. 7 illustrates an example in which a user interface 721 is provided when a user is doing an at-home workout while viewing content displayed on a TV.

Referring to FIG. 7, the user may perform a gaze-based head motion while gazing at one point in the display area 720 in order to input a user command while doing an at-home workout to follow the content displayed on the TV. Here, when the gaze-based head motion is detected by the camera 730 installed in the TV, a user interface 721 may be provided at the location at which the gaze 710 of the user is located in the display area 720. Here the displayed user interface 721 may be superimposed on the content being viewed by the user according to the gaze 710 of the user.

Here, the gaze-based head motion information may be a head motion recognized in the state in which the gaze is fixed, and whether to call a user interface may be determined depending on whether such gaze-based head motion information is detected.

For example, when gaze-based head motion information that is previously registered for a user is recognized, it is determined that the user performs a motion for giving a user command to a system, and a user interface may be called and displayed.

When the gaze of a user is not fixed at any one point although the gaze and the head motion of the user are detected, this is not recognized as gaze-based head motion information, so a user interface may not be displayed.

That is, in the present invention, a gaze may be used in order to set the location at which a user interface is to be displayed in the display area or to determine whether starting a command, maintaining a command state, inputting a command, or the like, recognized by sensing any of various head motions, is valid.

Therefore, according to the present invention, sensitivity to a distance or user movement may be relieved in the user command input method based on eye tracking.

For example, as long as the gaze and the head motion of a user are capable of being monitored even though the user is located distant from a camera, a user command may be recognized without disturbing the activity of the user.

Here, the process of registering a gaze-based head motion command for calling a user command reception mode will be described later when a process for registering a user is described.

Here, the user interface may provide a unique command set corresponding to a user.

For example, the unique command set corresponding to a user may be a command set customized by the user so as to have a form preferred by the user based on information recognized through natural user experience (UX) in various environments. Such a unique command set personalized to the user is provided in a form conveying great freedom, like a command set using a mouse or touch input, whereby a greater variety of user commands may be provided.

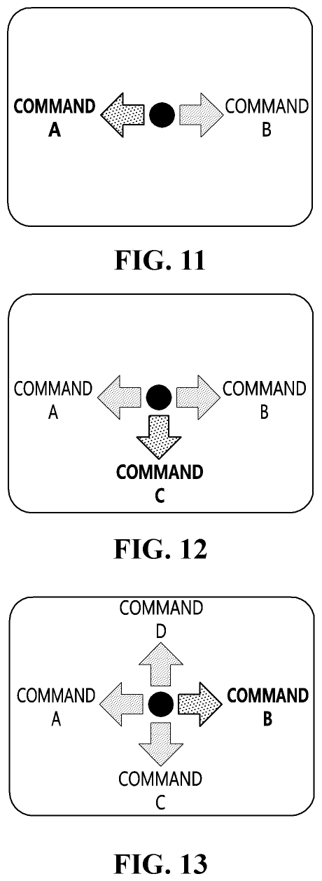

FIGS. 11 to 15 illustrate examples of a unique command set including a user command and direction indicators, and hereinafter, an example of a scenario in which a user command selected by a user is fed back will be described with reference to FIGS. 11 to 15.

FIGS. 11 to 13 illustrate unique command sets in a form in which a user command is capable of being selected by performing a head motion in the upward, downward, leftward, or rightward direction in the state in which a gaze is fixed.

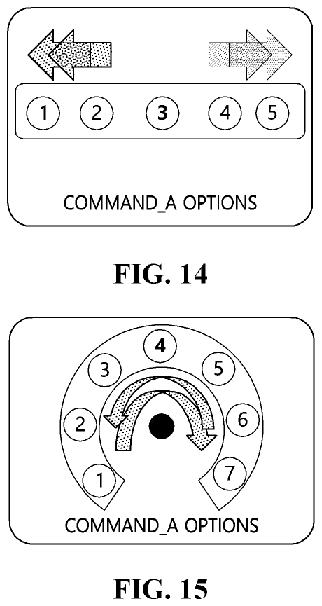

Also, FIGS. 14 to 15 illustrate a command set in a form in which, when a head is turned leftwards or rightwards while a gaze is fixed, any of commands corresponding to numbers consecutively arranged in the direction in which the head turns is capable of being selected when the head is kept turned.

For example, if the distance between a user and a camera is short and fixed and if a sufficient amount of light, stable supply of power, and sufficient computational capability are guaranteed, e.g., when a user is working on a document on a computer, a unique command set capable of simultaneously displaying a greater number of commands may be provided based on more sophisticated recognition of head motion directions such that a user command is capable of being selected therefrom.

Conversely, when transfer of a command from a long distance is required, as in a factory, facilities, or the like, a unique command set using a simple command system, e.g., selection of only the left or right, may be provided. That is, various unique command sets may be combined and selectively used depending on the system operating environment.

Here, the currently selected command, among commands registered in the unique command set, may be highlighted such that the user is able to recognize the selected command, as illustrated in FIGS. 11 to 15.

Here, the unique command sets illustrated in FIGS. 11 to 15 are an embodiment for a description thereof, and the command set may be set in various forms, without being limited to the illustrated form.

Here, the unique command set may be set to have a command list and a layout in consideration of the characteristics of the location at which the gaze is fixed in the display area.

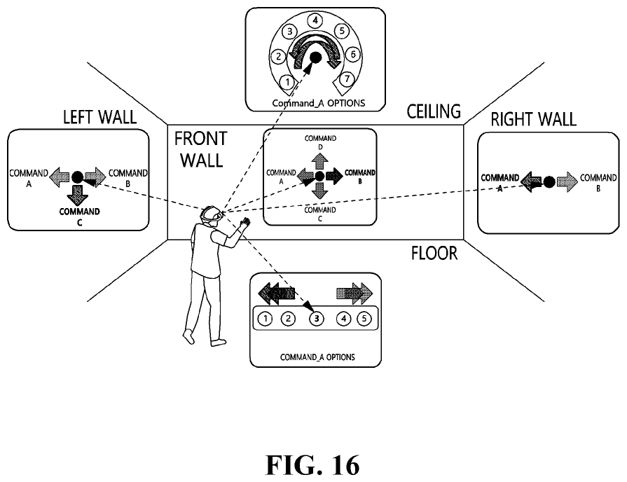

For example, FIG. 16 is a view illustrating an example of a unique command set, the command list of which is set differently depending on the display area characteristics according to the present invention.

Referring to FIG. 16, the display area viewed by a user wearing an HMD device is not limited to a fixed area, but may have spatial characteristics, as illustrated in FIG. 16. For example, when the location on which the gaze of the user is fixed is assumed to be the front wall in the display area provided through the HMD, a unique command set may be provided by configuring the command list thereof so as to include commands related to content that can be provided through the front wall. Also, when the location on which the gaze of the user is fixed is assumed to be a ceiling or a floor in the display area provided through the HMD, a unique command set may be provided by configuring the command list thereof so as to include commands related to content that can be provided only through the ceiling or the floor.

That is, referring to FIG. 16, the unique command set corresponding to the user may be set differently depending on the area characteristics of the location at which the gaze of the user is fixed, and may then be provided.

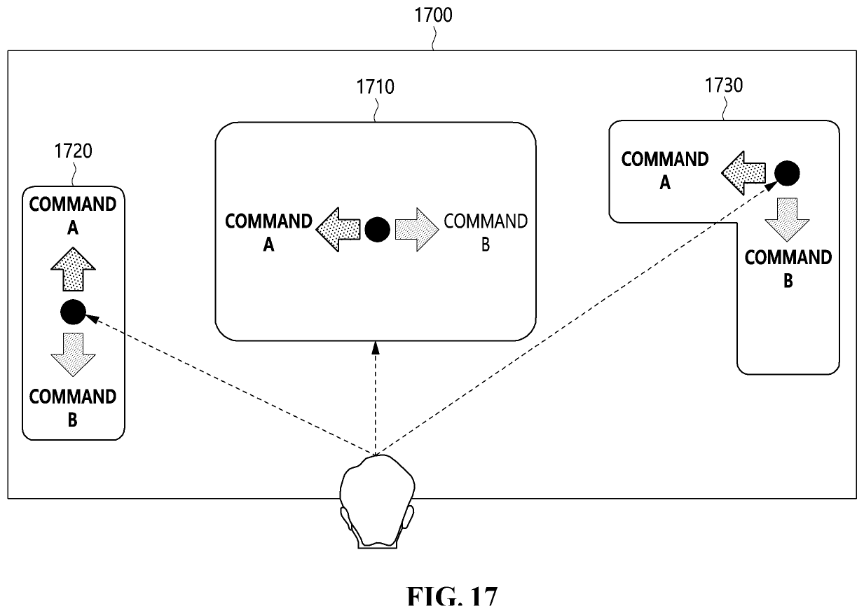

In another example, FIG. 17 is a view illustrating an example of a unique command set, the layout of which is set differently depending on the display area characteristics according to the present invention.

Referring to FIG. 17, unique command sets 1710 to 1730 including the same command list may have different layouts depending on the locations at which the unique command sets are displayed in the display area 1700. For example, it may be assumed that the basic layout has the form of the unique command set 1710 illustrated in FIG. 17 and that a user calls a user interface by looking at any of various locations in the display area 1700 corresponding to a large screen, such as a media wall. If the user calls a user interface while looking at the left edge of the display area 1700, the unique command set having a layout in which a command is capable of being selected by moving the head upwards or downwards, like the unique command set 1720, rather than the basic layout, may be provided. Also, if the user calls a user interface by looking at the upper-right corner of the display area 1700, a unique command set having a layout in which a command is capable of being selected by moving the head leftwards or downwards, like the unique command set 1730, may be provided.

As described above, the layout of a unique command set is changed depending on the location on which the gaze of a user is fixed in the display area 1700, whereby the user may more clearly and conveniently select a command through a head motion.

Here, a user interface may be displayed such that the gaze point at which the gaze of a user is located matches the center of the unique command set in order for the user to easily understand the configuration of the unique command set even when the user's gaze is fixed.

Also, in the method for recognizing a user command using non-contact gaze-based head motion information according to an embodiment of the present invention, the user command selected from the user interface is recognized at step S330.

For example, when a unique command set is displayed through a user interface, the user interface is controlled so as to match the detected gaze-based head motion information pertaining to a user, whereby a user command may be selected. That is, because the gaze-based head motion information corresponds to direction information input by a head motion in the state in which a gaze is fixed, a command located in the direction input through the head motion based on the gaze point at which the gaze is located may be selected.

For example, the direction information input through the head motion may be classified into a minimum of two directions and a maximum of eight directions.

The direction information may be set according to user preference, or may be set or changed in consideration of the environment in which the system is applied.

Here, the gaze-based head motion information may be detected in consideration of the head motion characteristics of the user.

Here, the head motion characteristics may include at least one of a head turn angle, a head turn speed, the time during which the head is kept turned, the time taken to turn back the head, and the positions of eyes and extents of opening of eyelids according to the turn of the head.

That is, because even the same head motion may differ somewhat between individuals, the head motion characteristics of each user are registered in advance, and may then be used to recognize the user command selected through the gaze-based head motion information.

For example, among multiple commands displayed in a unique command set, a user command located in the direction of the gaze-based head motion information, recognized in consideration of the head motion characteristics, may be selected.

If a unique command set has the form illustrated in FIG. 11, whether the direction of the gaze-based head motion information, recognized in consideration of the head motion characteristics, is the right or left is recognized, and the user command located in the recognized direction may be selected.

In another example, if a unique command set has the form illustrated in FIG. 12 or FIG. 13, whether the direction of the gaze-based head motion information, recognized in consideration of the head motion characteristics, is an upward, downward, leftward, or rightward direction is recognized, and the user command located in the recognized direction may be selected.

In another example, if a unique command set has the form illustrated in FIG. 14, whether the direction of the gaze-based head motion information, recognized in consideration of the head motion characteristics, is the left or right is detected first, and then a user command corresponding to one of the consecutively arranged numbers may be selected in consideration of the time during which the head is kept turned in the corresponding direction.

That is, when a user intends to select the user command corresponding to number ‘1’ in the unique command set illustrated in FIG. 14, the user may turn his/her head to the left and keep the head turned until number ‘1’ is selected. Then, when number ‘1’ is selected, the user turns back the head to look straight ahead, thereby selecting the user command corresponding to number ‘1’.

Also, a user command may be selected using the unique command set illustrated in FIG. 15 in a manner similar to that described with reference to FIG. 14. That is, whether the direction of gaze-based head motion information is the right or left is recognized first, and while the head is kept turned in the recognized direction, numbers revolve, whereby the number to be selected may be changed. Here, the user command corresponding to the number that is selected when the user turns back the head to look straight ahead may be selected.

Also, although not illustrated in FIG. 3, in the method for recognizing a user command using non-contact gaze-based head motion information according to an embodiment of the present invention, whether the monitored user is a registered user may be determined.

If the user is a registered user having authority to give a user command to a system, whether to execute a user command may be determined based on criteria for processing a command for each head motion characteristic.

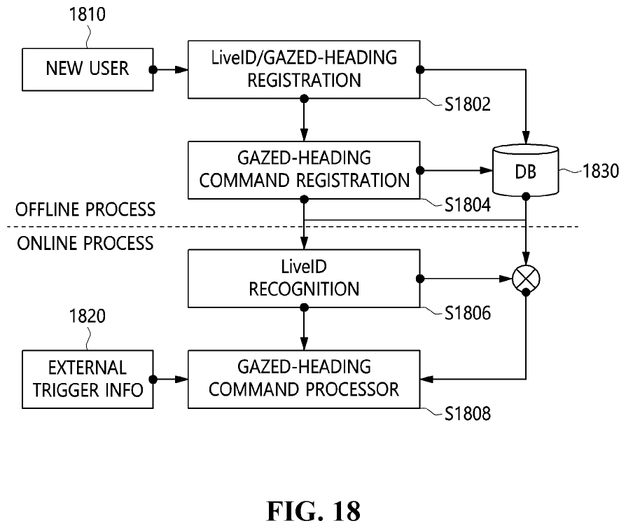

For example, the process of recognizing a user command according to an embodiment of the present invention may include an online process and an offline process, as illustrated in FIG. 18, and the steps illustrated in FIG. 3 may correspond to step S1808 of the online process.

Here, step S1808 may be performed by being activated by a user, as in the examples described above, and may also be activated when a system requests a user to make a specific determination depending on the circumstances. When step S1808 is activated by a system, external trigger information 1820 may be input.

For example, when the automated driving level of an autonomous driving system is equal to or higher than level 3, a driver does not need to manually drive a vehicle. However, when the road conditions are too ambiguous for the autonomous driving system to determine, the system may require intervention or a determination on the part of the driver. If it is difficult for the driver to immediately switch to manual driving, the method for recognizing a user command according to an embodiment of the present invention may be applied.

In the event of an emergency, the system may call a user using an HUD, sound, or the like, and may display the condition for which the determination by the user is required in the HUD in real time. In this case, the user determines the condition, the determination of which is requested by the system, and may give a user command through a gaze-based head motion command based on the unique command set displayed in a GUI window even in the state in which the user is not in a driving posture (or it is difficult to immediately return to the posture).

Here, the system may identify the main driver of a vehicle, and may preferentially receive a command from the identified driver. When an autonomous driving function is incomplete, this scenario may prevent the occurrence of an accident in a vehicle having an automated driving level equal to or higher than 3, or may enable the function of a black box capable of determining a system or user fault when a vehicle accident occurs.

Also, although not illustrated in FIG. 3, in the method for recognizing a user command using non-contact gaze-based head motion information according to an embodiment of the present invention, multiple gaze-based head motions corresponding to a user are acquired, and the user is registered by matching head motion characteristics, extracted based on the multiple gaze-based head motions, with user identification information.

For example, the user registration process may correspond to step S1802 of the offline process illustrated in FIG. 18.

That is, a new user 1810 may perform user registration through step S1802 illustrated in FIG. 18, and registering the head motion characteristics of the user may be performed simultaneously with this process.

Here, user identification information for identifying a user and the head motion characteristics thereof may be registered in a database 1830 based on a user ID, and when an online process is performed, the data registered in the database 1830 may be retrieved and used.

Here, technology for user recognition, detection of a head motion or a head pose, detection of an eye gaze, and the like for user registration may be variously implemented through conventional technology in the computer vision and AI fields.

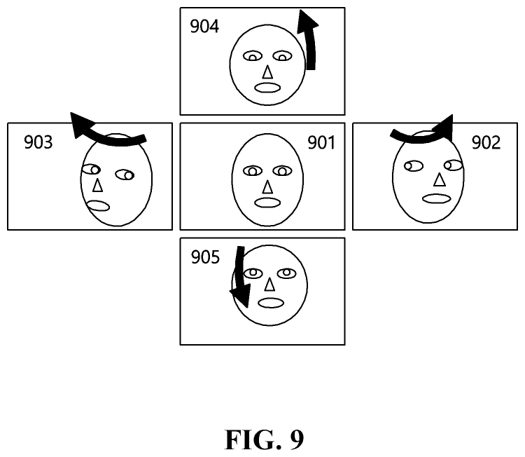

A user registration process will be described as follows with reference to FIGS. 8 to 9.

First, a user 800 may perform a head motion by turning the head in any of upward, downward, leftward and rightward directions 842 to 845 while placing his/her gaze 810 at the gaze point 841 displayed in a display area 830. Here, face images 901 to 905 for the respective directions are acquired, as shown in FIG. 9, by capturing an image of the head motion 811 of the user 800 using a camera 820, whereby user registration and calibration of head motion characteristics of each user may be performed based thereon.

Here, a motion-inducing message may be output in order to induce a user to perform multiple gaze-based head motions.

Here, the head motion characteristics may be calibrated in consideration of the difference between a first motion, promoted by the motion-inducing message, and a second motion, corresponding to the multiple gaze-based head motions.

For example, the motion-inducing message may be output by randomly presenting the gaze point 841 and the head motion directions 842 to 845 in the user interface 840 illustrated in FIG. 8. When a motion-inducing message prompting to turn the head to the right and then turn back the head is output, the head turn angle, the head turn speed, the time during which the head is kept turned, the time taken to turn back the head, the positions of eyes and extents of opening of eyelids according to the turn of the head, and the like are acquired while the user performs the head motion in the rightward direction, and then the unique head motion characteristics of the user for the head motion in the rightward direction may be calibrated based thereon.

Here, the head motion characteristics may be calibrated while the location of the gaze point for prompting to perform the multiple gaze-based head motions is moved.

That is, the motion that a system requests a user to perform through a motion-inducing message may vary in consideration of the characteristics or scenario of a gaze-based head motion command for receiving a user command.

For example, when a display area is large, gaze-based head motions are acquired while the location of the gaze point in the display area is moved, and head motion characteristics may be calibrated based thereon.

Also, although not illustrated in FIG. 3, in the method for recognizing a user command using non-contact gaze-based head motion information according to an embodiment of the present invention, gaze-based head motion commands, including a gaze-based head motion command for calling a user interface, a gaze-based head motion command for selecting a user command from a unique command set, a gaze-based head motion command for approving execution of the user command selected from the unique command set, and the like, may be registered.

For example, the process of registering a gaze-based head motion command may correspond to step S1804 of the offline process illustrated in FIG. 18.

Here, a gaze-based head motion command for calling a user interface is a command for instructing a system to switch to a mode in which the system is capable of receiving a user command, and may be configured simply or variously depending on the user requirements or the environment in which the system is applied.

For example, if driver A seldom lifts his/her head up while driving, the behavior of lifting the head up while fixing the gaze while driving may be registered as a gaze-based head motion command for calling a user interface.

In another example, in the case of driver B, the behavior of nodding the head while fixing the gaze while driving may be registered as a gaze-based head motion command for calling a user interface.

That is, a motion that is seldom performed by a user is registered as the gaze-based head motion command for calling a user interface, whereby the system may effectively differentiate the command for calling a user interface from meaningless motions.

Also, a gaze-based head motion command for selecting a user command from the unique command set may be registered.

For example, it may be assumed that the unique command set has the form illustrated in FIG. 11. Here, the gaze-based head motion command may be registered such that, when a user turns his/her head to the right or left and turns the head back while gazing at the center of the unique command set, the command located in the direction in which the head turns is selected.

Also, a gaze-based head motion command for approving execution of the user command selected from the unique command set is registered, whereby final approval for execution of the command may be received from the user.

That is, the system may execute the user command selected by the user after receiving approval from the user.

For example, in the state in which the user command corresponding to Command A is recognized as shown in FIG. 11, when the user performs a head motion of nodding the head while fixing the gaze, it is determined that final approval for execution of Command A is completed, and Command A may be executed.

Here, depending on the type of user command, the user command may be executed immediately, without a final approval process.

For example, in the case of a user command that has to be executed immediately in an environment such as a factory, an industrial site, or the like, the user command may be executed immediately upon recognition thereof. That is, settings may be made such that, when factory worker C calls a user interface for a command for urgently stopping a system and then performs a motion of shaking his/her head from side to side while gazing at a camera, the command for urgently stopping the system is executed immediately by skipping the final approval process. Here, the system may determine whether factory worker C has authority to execute the command for urgently stopping the system, and may execute the command when it is determined that factory worker C has authority to execute the command.

The gaze-based head motion command may be set to have a form in which user preferences or a system operating environment are taken into consideration and then registered, without being limited to the above examples.

The gaze-based head motion commands registered as described above may be stored for each user ID, and may be used by being called when the online process illustrated in FIG. 18 is performed.

Also, although not illustrated in FIG. 3, in the method for recognizing a user command using non-contact gaze-based head motion information according to an embodiment of the present invention, identification information of a user is acquired in real time using a camera, the user is identified by comparing the identification information with user information previously registered in a database, and whether the identified user is an actual user, that is, whether the user is alive, may be checked.

For example, in the case of a driving system to which the configuration of the present invention is applied, the procedure of checking whether user A sitting in a driver's seat is actually user A, who is eligible to drive a vehicle, may be performed through a user command recognition system according to the present invention. Here, the user information registered in the DB 1830 illustrated in FIG. 18 is compared with the identification information of the user input in real time through a camera, whereby user A may be identified.

Here, whether the user is alive may be checked. That is, whether the user image input through the camera is the user image generated by capturing an image of the actual user in real time, rather than an image that is input using a picture, video, or technology for making a fake image, may be checked.

For example, in the case of a driving system to which the configuration of the present invention is applied, whether a user is alive may be checked by requesting the user to select a command in an arbitrary direction within a preset time using a GUI displayed in an HUD.

When a higher level of user identification or checking is required, the head motion characteristics registered as pertaining to the user in the user registration process are compared, whereby the identity of the user and whether the user is alive may be checked.

Here, when it is confirmed that the user is a previously registered user and that the user appears to be alive, the previously registered data pertaining to the user may be retrieved in order to recognize a user command received from the user.

For example, when step S1806 illustrated in FIG. 18 is completed, the previously registered data pertaining to the user is retrieved from the database 1830 and loaded into the system such that the user command recognition process is performed at step S1808.

Here, the previously registered data pertaining to the user may be information about the gaze-based head motion command registered through step S1804 illustrated in FIG. 18.

Using the above-described method for recognizing a user command using non-contact gaze-based head motion information, an interface for inputting a user command is displayed at the location at which the gaze of a user remains, without disturbing the situation in which the user uses his/her body for a desired activity or in which the user is required to keep looking ahead, whereby the user command may be issued to a system.

Also, a user command may be given to a system in real time in an interactive manner using the minimum possible amount of movement.

Also, technology capable of being used in various fields in which a user needs to give a command to a system in real time through AI based on analysis of an image of the face of the user may be provided by replacing, supplementing, or assisting the conventional user command transfer system.

Also, various user commands recognized through natural user experience (UX) may be transferred to a system in an interactive manner in various environments in which contact-based input or non-contact-based input is used.

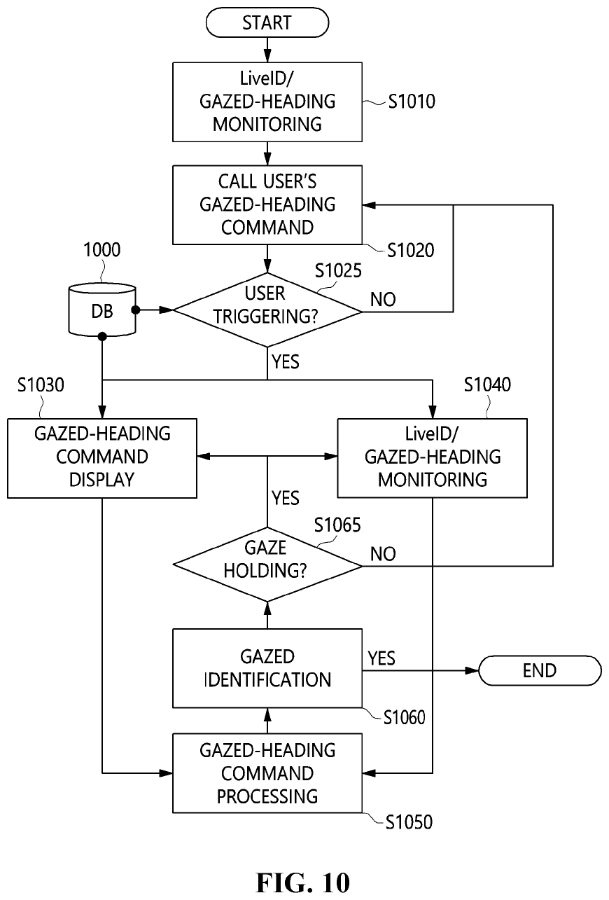

FIG. 10 is a flowchart illustrating in detail the process of processing a gaze-based head motion command in a user command recognition process according to an embodiment of the present invention.

Referring to FIG. 10, in the process of processing a gaze-based head motion command in the user command recognition process, first, a unique command set registered by a user through an offline process is received from a DB 1000, the user ID of the user in the image captured using a camera is checked, and both the gaze and the head motion of the user may be monitored based on the captured image at step S1010.

Subsequently, information about the gaze-based head motion commands previously registered in the DB 1000 by the user is retrieved at step S1020, and whether the user calls a user interface through the gaze-based head motion command may be determined based on the monitoring result at step S1025.

Here, the previously registered gaze-based head motion command may be a command that is set and registered in a form in which user preferences or the system operating environment are taken into consideration.

When it is determined at step S1025 that the user interface is called, a main command set predefined by the user may be displayed at step S1030.

For example, the unique command set included in the user interface may be displayed at the location of the gaze point of the user on the display device, such as an HMD.

Simultaneously, the system may monitor the direction of the gaze-based head motion command performed by the user, among the commands included in the unique command set displayed as a GUI, at step S1040.

Here, the head motion characteristics that appear when the user gives the gaze-based head motion command may be monitored.

Then, in the unique command set, the user command that matches the direction corresponding to the gaze-based head motion information is recognized, whereby the command may be executed at step S1050.

Here, whether to execute the recognized user command may be determined based on the monitored head motion characteristics of the user and predefined criteria for processing the command for each head motion characteristic.

Here, whether the user has authority to give the corresponding command may also be determined.

Subsequently, the gaze information of the user is checked at step S1060, and whether the user continues to gaze at the initial gaze point may be determined at step S1065 based on the checked information.

When it is determined at step S1065 that the user continues to gaze at the initial gaze point, a subcommand set is displayed, and steps S1030 and S1040 may be activated and performed.

When it is determined at step S1065 that the user is no longer gazing at the initial gaze point, displaying the unique command set is stopped, and monitoring may be performed through step S1010.

Also, when it is determined at step S1025 that the user interface is not called, the process goes back to step S1010, whereby whether a user interface is called may be continuously determined.

Through the above-described flow, the gaze and the head motion of a user may be regularly monitored, and the gaze-based head motion command by the user may be received and processed in real time in an interactive manner.

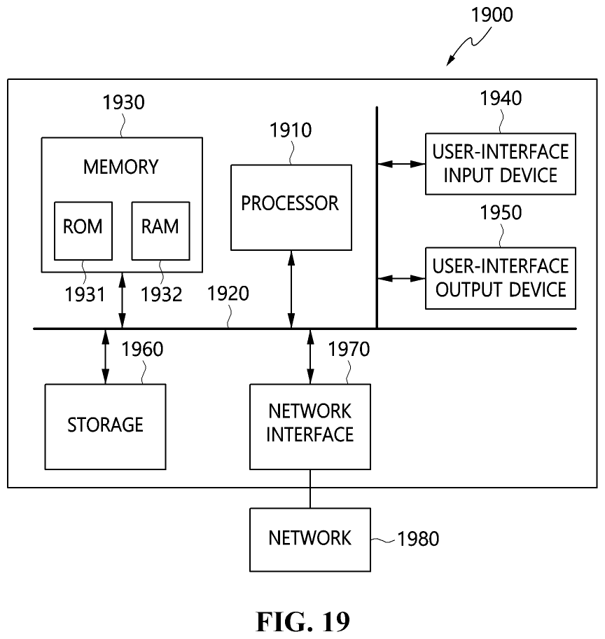

FIG. 19 is a view illustrating an apparatus for recognizing a user command using non-contact gaze-based head motion information according to an embodiment of the present invention.

Referring to FIG. 19, the apparatus for recognizing a user command using non-contact gaze-based head motion information according to an embodiment of the present invention may be implemented as a computer system including a computer-readable recording medium, as illustrated in FIG. 19. As shown in FIG. 19, the computer system 1900 may include one or more processors 1910, memory 1930, a user-interface input device 1940, a user-interface output device 1950, and storage 1960, which communicate with each other via a bus 1920. Also, the computer system 1900 may further include a network interface 1970 connected to a network 1980. The processor 1910 may be a central processing unit or a semiconductor device for executing processing instructions stored in the memory 1930 or the storage 1960. The memory 1930 and the storage 1960 may be any of various types of volatile or nonvolatile storage media. For example, the memory may include ROM 1931 or RAM 1932.

Accordingly, an embodiment of the present invention may be implemented as a non-transitory computer-readable storage medium in which methods implemented using a computer or instructions executable in a computer are recorded. When the computer-readable instructions are executed by a processor, the computer-readable instructions may perform a method according to at least one aspect of the present invention.

Hereinafter, a description will be made with a focus on the apparatus for recognizing a user command using non-contact gaze-based head motion information according to an embodiment of the present invention.

The processor 1910 monitors the gaze and the head motion of a user using a sensor.

Here, gaze-based head motion information may be detected in consideration of the head motion characteristics of the user.

Here, the gaze-based head motion information may be direction information input by the head motion in the state in which the gaze is fixed.

Here, the head motion characteristics may include at least one of a head turn angle, a head turn speed, the time during which the head is kept turned, the time taken to turn back the head, and the positions of eyes and extents of opening of eyelids according to the turn of the head.

Also, the processor 1910 may display a user interface at the location corresponding to the gaze based on the gaze-based head motion information acquired by combining the gaze and the head motion.

Here, the location at which the user interface is displayed may change so as to match the location at which the gaze is fixed in a display area, and the display area may be a large display that is wider than the field of view of the user.

Here, the user interface may provide a unique command set for the user.

Here, the unique command set may be set so as to match a command list and a layout in which the area characteristics of the location on which the gaze is fixed in the display area are taken into consideration.

Also, the processor 1910 recognizes the user command selected from the user interface.

Also, the processor 1910 acquires multiple gaze-based head motions of the user and matches head motion characteristics, extracted based on the multiple gaze-based head motions, with the user identification information, thereby registering the user.

Here, a motion-inducing message for prompting to perform the multiple gaze-based head motions may be output.

Here, the head motion characteristics may be calibrated in consideration of the difference between a first motion, prompted by the motion-inducing message, and a second motion, corresponding to the multiple gaze-based head motions.

Here, the head motion characteristics may be calibrated while the location of the gaze point for prompting to perform the multiple gaze-based head motions is moved.

The memory 1930 stores the user interface.

Also, the memory 1930 stores various kinds of information generated in the above-described process of recognizing a user command using non-contact gaze-based head motion information according to an embodiment of the present invention.

According to an embodiment, the memory 1930 may be separate from the apparatus for recognizing a user command using non-contact gaze-based head motion information, corresponding to the computer system illustrated in FIG. 19, and may support the function for recognizing a user command using non-contact gaze-based head motion information. Here, the memory 1930 may operate as separate mass storage, and may include a control function for performing operations.

Meanwhile, the apparatus for recognizing a user command using non-contact gaze-based head motion information includes memory installed therein, whereby information may be stored therein. In an embodiment, the memory is a computer-readable medium. In an embodiment, the memory may be a volatile memory unit, and in another embodiment, the memory may be a nonvolatile memory unit. In an embodiment, the storage device is a computer-readable recording medium. In different embodiments, the storage device may include, for example, a hard-disk device, an optical disk device, or any other kind of mass storage device.

Using the above-described apparatus for recognizing a user command using non-contact gaze-based head motion information, an interface for inputting a user command is displayed at the location at which the gaze of a user is fixed, without disturbing the situation in which the user uses his/her body for a desired activity or in which the user is required to keep looking forwards, whereby the user command may be transferred to a system.

Also, a user command may be given to a system in real time in an interactive manner using the minimum possible amount of movement.

Also, technology capable of being used in various fields in which a user needs to give a command to a system in real time through AI based on analysis of an image of the face of the user may be provided by replacing, supplementing, or assisting the conventional user command transfer system.

Also, various user commands recognized through natural user experience (UX) may be issued to a system in an interactive manner in various environments in which contact-based input or non-contact-based input is used.

According to the present invention, an interface for inputting a user command is displayed at the location at which the gaze of a user remains, without disturbing the situation in which the user uses his/her body for a desired activity or in which the user is required to keep looking forwards, whereby the user command may be given to a system.

Also, the present invention may enable a user command to be issued to a system in real time in an interactive manner using the minimum possible amount of movement.

Also, the present invention may provide technology capable of being used in various fields in which a user needs to give a command to a system in real time through Artificial Intelligence (AI) based on analysis of an image of the face of a user by replacing, supplementing, or assisting the conventional user command transfer system.

Also, the present invention may enable various user commands recognized through natural user experience (UX) to be issued to a system in an interactive manner in various environments in which contact-based input or non-contact-based input is used.

Also, the present invention may overcome the limitation of a large display, such as a media wall or the like, in which it is difficult to receive a user command merely by disposing a conventional GUI for receiving the user command, and may enable an individual user to transfer a desired command at a location at which the user can comfortably gaze by providing a preset GUI command set at the location on the large display at which the gaze of the user remains.

As described above, the apparatus for recognizing a user command using non-contact gaze-based head motion information and the method using the same according to the present invention are not limitedly applied to the configurations and operations of the above-described embodiments, but all or some of the embodiments may be selectively combined and configured, so the embodiments may be modified in various ways.

What is claimed is:

1. A method for recognizing a user command, comprising:
monitoring a gaze and a head motion of a user based on a sensor;
displaying a user interface at a location corresponding to the gaze based on gaze-based head motion information acquired by combining the gaze and the head motion; and
recognizing a user command selected from the user interface.

2. The method of claim 1, wherein:
the location at which the user interface is displayed changes so as to match a location on which the gaze is fixed in a display area, and the display area is a large display wider than a field of view of the user.

3. The method of claim 2, wherein:
the user interface provides a unique command set corresponding to the user.

4. The method of claim 1, wherein:
the gaze-based head motion information corresponds to direction information input by the head motion in a state in which the gaze is fixed.

5. The method of claim 4, wherein:
monitoring the gaze and the head motion comprises detecting the gaze-based head motion information in consideration of head motion characteristics of the user.

6. The method of claim 5, wherein:
the head motion characteristics include at least one of a head turn angle, a head turn speed, a time during which a head is kept turned, a time taken to turn back the head, and positions of eyes and extents of opening of eyelids according to the turn of the head.

7. The method of claim 6, further comprising:
acquiring multiple gaze-based head motions of the user and matching the head motion characteristics extracted based on the multiple gaze-based head motions with user identification information, thereby registering the user.

8. The method of claim 7, wherein registering the user includes:
outputting a motion-inducing message for prompting to perform the multiple gaze-based head motions; and
calibrating the head motion characteristics in consideration of a difference between a first motion prompted by the motion-inducing message and a second motion corresponding to the multiple gaze-based head motions.

9. The method of claim 8, wherein:
calibrating the head motion characteristics comprises calibrating the head motion characteristics while moving a location of a gaze point for prompting to perform the multiple gaze-based head motions.

10. The method of claim 3, wherein:
the unique command set is set so as to correspond to a command list and a layout in which area characteristics of the location on which the gaze is fixed in a display area are taken into consideration.

11. An apparatus for recognizing a user command, comprising:
a processor for monitoring a gaze and a head motion of a user based on a sensor, displaying a user interface at a location corresponding to the gaze based on gaze-based head motion information acquired by combining the gaze and the head motion, and recognizing a user command selected from the user interface; and
memory for storing the user interface.

12. The apparatus of claim 11, wherein:
the location at which the user interface is displayed changes so as to match a location on which the gaze is fixed in a display area, and the display area is a large display wider than a field of view of the user.

13. The apparatus of claim 12, wherein:
the user interface provides a unique command set corresponding to the user.

14. The apparatus of claim 11, wherein:
the gaze-based head motion information corresponds to direction information input by the head motion in a state in which the gaze is fixed.

15. The apparatus of claim 14, wherein:
the processor detects the gaze-based head motion information in consideration of head motion characteristics of the user.

16. The apparatus of claim 15, wherein:
the head motion characteristics include at least one of a head turn angle, a head turn speed, a time during which a head is kept turned, a time taken to turn back the head, and positions of eyes and extents of opening of eyelids according to the turn of the head.

17. The apparatus of claim 16, wherein:
the processor acquires multiple gaze-based head motions of the user and matches the head motion characteristics extracted based on the multiple gaze-based head motions with user identification information, thereby registering the user.

18. The apparatus of claim 17, wherein:
the processor outputs a motion-inducing message for prompting to perform the multiple gaze-based head motions and calibrates the head motion characteristics in consideration of a difference between a first motion prompted by the motion-inducing message and a second motion corresponding to the multiple gaze-based head motions.

19. The apparatus of claim 18, wherein:
the processor calibrates the head motion characteristics while moving a location of a gaze point for prompting to perform the multiple gaze-based head motions.

20. The apparatus of claim 13, wherein:
the unique command set is set so as to correspond to a command list and a layout in which area characteristics of the location on which the gaze is fixed in a display area are taken into consideration.
